(19) United States
(12) Patent Application Publication
(10) Pub. No.: US 2024/0160715 A1
(43) Pub. Date: May 16, 2024

(54) SUBJECT DETERMINATION APPARATUS, SUBJECT DETERMINATION METHOD, AND NON-TRANSITORY COMPUTER-EXECUTABLE MEDIUM

(71) Applicant: PFU LIMITED, Ishikawa (JP)

(72) Inventor: Akira IWAYAMA, Ishikawa (JP)

(21) Appl. No.: 18/505,979

(22) Filed: Nov. 9, 2023

(30) Foreign Application Priority Data
Nov. 10, 2022 (JP) 2022-180075

(51) Int. Cl. G06F 21/32; G06F 3/14; G09G 5/377

(52) U.S. Cl. CPC G06F 21/32; G06F 3/14; G09G 5/377

(57) ABSTRACT

A subject determination apparatus includes a display having a display screen, a camera to capture a subject, and circuitry. The circuitry displays a pattern image on the display screen. The circuitry obtains an image including the subject while the pattern image is being displayed on the display screen as a captured image. The circuitry determines whether the pattern image reflected by the subject appears in the captured image.

### CROSS-REFERENCE TO RELATED APPLICATION

This patent application is based on and claims priority pursuant to 35 U.S.C. § 119(a) to Japanese Patent Application No. 2022-180075, filed on Nov. 10, 2022, in the Japan Patent Office, the entire disclosure of which is hereby incorporated by reference herein.

### BACKGROUND

### Technical Field

Embodiments of the present disclosure relate to a subject determination apparatus, a subject determination method, and a non-transitory computer-executable medium.

### Related Art

Personal authentication apparatuses are known in the art that perform personal authentication using an image of the face of an individual. Further, personal authentication apparatuses are known that determine whether a subject in an image is a human face or a counterfeit such as a photograph of a face, to prevent identity fraud.

### SUMMARY

According to an embodiment of the present disclosure, a subject determination apparatus includes a display having a display screen, a camera to capture a subject, and circuitry. The circuitry displays a pattern image on the display screen. The circuitry obtains an image including the subject while the pattern image is being displayed on the display screen as a captured image. The circuitry determines whether the pattern image reflected by the subject appears in the captured image.

According to an embodiment of the present disclosure, a subject determination method includes displaying a pattern image on a display screen. The subject determination method includes, by a camera, capturing an image including a subject while the pattern image is being displayed on the display screen to obtain a captured image. The subject determination method includes determining whether the pattern image reflected by the subject appears in the captured image.

According to an embodiment of the present disclosure, a non-transitory computer-executable medium storing a plurality of instructions, which, when executed by one or more processors of a computer, causes the one or more processors to perform a method is provided. The method includes displaying a pattern image on a display screen. The method includes, by a camera, capturing an image including a subject while the pattern image is being displayed on the display screen to obtain a captured image. The method includes determining whether the pattern image reflected by the subject appears in the captured image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a personal authentication apparatus provided with a subject determination apparatus, according to Embodiment 1 of the present disclosure;

FIG. 2 is a schematic side view of the personal authentication apparatus, according to an embodiment of the present disclosure;

FIG. 3 is a block diagram illustrating the personal authentication apparatus, according to an embodiment of the present disclosure;

FIG. 4 is a diagram illustrating a screen created by a display control unit, according to an embodiment of the present disclosure;

FIG. 5 is a diagram illustrating another screen on which a second pattern image different from a first pattern image among multiple pattern images is displayed, according to an embodiment of the present disclosure;

FIG. 6 is a flowchart of an operation performed by the personal authentication apparatus, according to an embodiment of the present disclosure;

FIG. 7 is a schematic side view of the personal authentication apparatus and an identity fraud identification (ID) card when a user performs identity fraud with the identity fraud ID card;

FIG. 8 is a plan view of the identity fraud ID card brought close to a camera illustrated in FIG. 7;

FIG. 9 is a plan view of an identity fraud printed matter brought close to the camera;

FIG. 10 is a plan view of an identity fraud smartphone brought close to the camera;

FIG. 11 is a diagram illustrating an identity fraud captured image captured by the camera, according to an embodiment of the present disclosure;

FIG. 12 is a diagram illustrating a captured image captured by the camera when a person's face is placed in an image capturing space, according to an embodiment of the present disclosure;

FIG. 13 is a diagram illustrating another identity fraud captured image captured by the camera, according to an embodiment of the present disclosure; and

FIG. 14 is a diagram illustrating a screen used in a subject determination apparatus according to Embodiment 2 of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of a subject determination apparatus, a subject determination method, and a non-transitory computer-executable medium are described below with reference to the drawings. The technologies of the present disclosure are not limited to those in the following description. In the following description, like reference signs denote like elements, and redundant description thereof is simplified or omitted.

### Embodiment 1

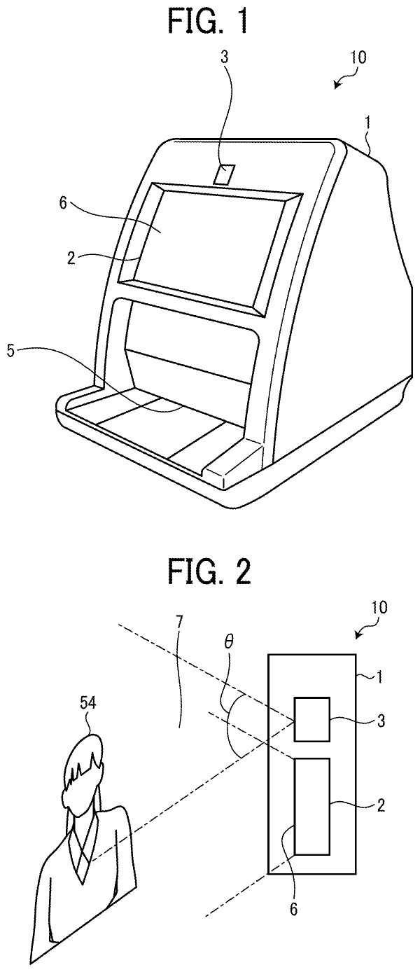

As illustrated in FIG. 1, a subject determination apparatus according to Embodiment 1 is provided for a personal authentication apparatus 10. FIG. 1 is a perspective view of the personal authentication apparatus 10 provided with the subject determination apparatus according to Embodiment 1. The personal authentication apparatus 10 includes a housing 1, a display device 2, and a camera 3. The housing 1 has a box-like shape. An identity verification document insertion slot 5 is formed in a front side of the housing 1. Examples of the display device 2 include, but are not limited to, a liquid crystal display (LCD). A display screen 6 is formed on the display device 2.

FIG. 2 is a schematic side view of the personal authentication apparatus 10. The display device 2 is attached to the housing 1 so that the display screen 6 faces an image capturing space 7 in front of the housing 1. The camera 3 is disposed above the display screen 6 of the display device 2 so as to capture an image including a subject present in the image capturing space 7. The camera 3 is attached to the housing 1 and its position with respect to the display device 2 is defined via the housing 1. The angle of view θ of the camera 3 has a fixed value. In other words, when the distance between the camera 3 and the subject has a fixed value, the size of an image of the subject in the image captured by the camera 3 has a fixed value. The longer the distance between the camera 3 and the subject, the smaller the image of the subject in the image captured by the camera 3. The shorter the distance between the camera 3 and the subject, the bigger the image of the subject in the image captured by the camera 3.

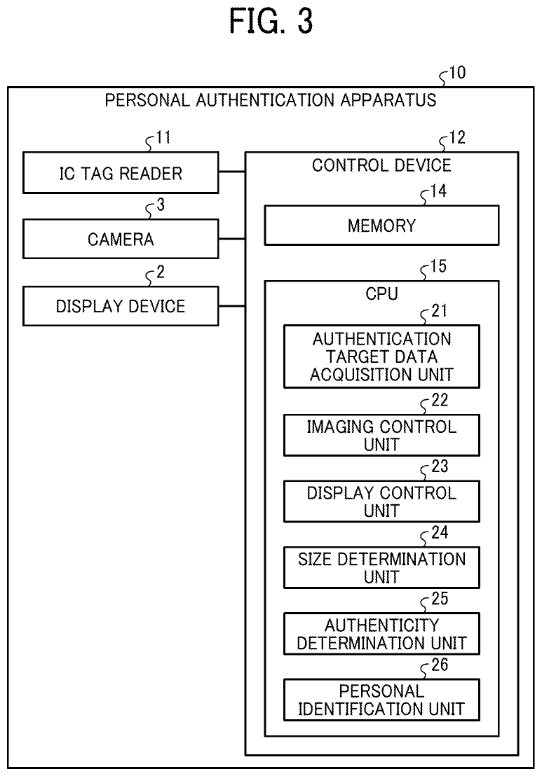

FIG. 3 is a block diagram illustrating a configuration of the personal authentication apparatus 10. The personal authentication apparatus 10 further includes an integrated circuit (IC) tag reader 11 and a control device 12. The IC tag reader 11 is disposed inside the housing 1. The IC tag reader 11 reads information from an IC tag embedded in an identity verification document inserted into the identity verification document insertion slot 5 via a radiofrequency identification (RFID). In other words, the IC tag reader 11 reads information recorded in the IC tag by transmitting an inquiry radio wave and receiving a response radio wave transmitted from the IC tag using power generated by the inquiry radio wave.

The control device 12 is a computer, and includes a memory 14 and a central processing unit (CPU) 15. In the memory 14, a computer program to be installed in the control device 12 is recorded, and information used by the CPU 15 is recorded. The CPU 15 executes the computer program installed in the control device 12 to perform information processing, control the memory 14, and further control the display device 2, the camera 3, and the IC tag reader 11. The memory 14 also stores multiple pattern images.

The computer program installed in the control device 12 includes multiple computer programs for causing the control device 12 to implement multiple functions. The multiple functions include an authentication target data acquisition unit 21, an imaging control unit 22, a display control unit 23, a size determination unit 24, an authenticity determination unit 25, and an individual identification unit 26.

The authentication target data acquisition unit 21 controls the IC tag reader 11 to acquire face data recorded in the IC tag embedded in the identity verification document inserted into the identity verification document insertion slot 5 from the IC tag. The imaging control unit 22 controls the camera 3 to capture an image including a subject present in the image capturing space 7. The display control unit 23 creates a screen image and controls the display device 2 to display the created screen image on the display screen 6. The size determination unit 24 performs image processing on the captured image captured by the imaging control unit 22 and calculates the size of the face image in the captured image.

When the size of the face image calculated by the size determination unit 24 is within a specified size range that is determined in advance, the authenticity determination unit 25 performs image processing on the captured image captured by the imaging control unit 22 and determines whether a predetermined pattern image appears in the captured image. When the authenticity determination unit 25 determines that the pattern image does not appear in the captured image, the individual identification unit 26 performs image processing on the captured image captured by the imaging control unit 22, and determines whether a face in the captured image is the same as a face represented by the face data acquired by the authentication target data acquisition unit 21. Any known algorithm can be used as an algorithm for determining whether the face in the captured image is the same as the face represented by the face data acquired by the authentication target data acquisition unit 21.

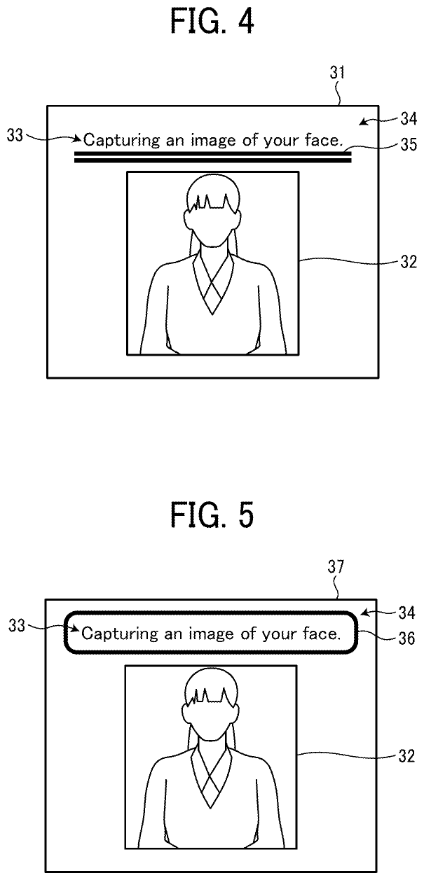

As illustrated in FIG. 4, the screen image 31 created by the display control unit 23 includes a captured image area 32, a message area 33, and a pattern image area 34. FIG. 4 is a diagram illustrating the screen image 31 created by the display control unit 23. The captured image area 32 is substantially in the center of the screen image 31. A captured image captured by the camera 3 is displayed in the captured image area 32. The message area 33 is a portion of the screen image 31 between the upper edge of the screen image 31 and the captured image area 32, near the upper edge of the screen image 31. In the message area 33, a message that guides a user using the personal authentication apparatus 10 is displayed. The pattern image area 34 may be positioned outside of the captured image area 32. The pattern image area 34 may overlap with the captured image area 32.

The pattern image area 34 is a portion of the screen image 31 between the upper edge of the screen image 31 and the captured image area 32, near the upper edge of the screen image 31. In other words, when the screen image 31 is displayed on the display screen 6, the pattern image area 34 is displayed near the edge of the display screen 6 closer to the camera 3. One of multiple pattern images is displayed in the pattern image area 34. The pattern images include, for example, a first pattern image 35. The first pattern image 35 is formed of double lines along two parallel lines.

The multiple pattern images are different from each other. In other words, as illustrated in FIG. 5, the shape of a second pattern image 36 that is different from the first pattern image 35 among the multiple pattern images is different from the shape of the first pattern image 35. FIG. 5 is a diagram illustrating another screen 37 on which the second pattern image 36 different from the first pattern image 35 among the multiple pattern images is displayed. The second pattern image 36 includes double lines along two parallel lines. The spacing between the double lines of the second pattern image 36 is wider than the spacing between the double lines of the first pattern image 35. The multiple pattern images may include a message, a character, or a text. The multiple pattern images may include a graphic image. The display control unit 23 may display the first pattern image 35 or the second pattern image 36 in an area different from the captured image area.

Operation by Personal Authentication Apparatus 10

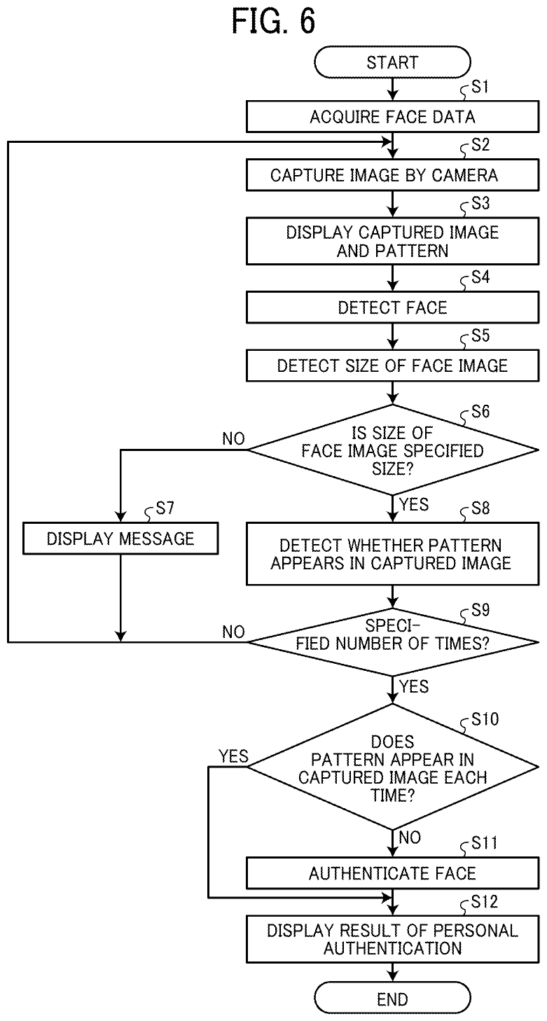

FIG. 6 is a flowchart of an operation performed by the personal authentication apparatus 10. When a user wants to authenticate himself or herself using the personal authentication apparatus 10, the user inserts the identity verification document embedded with an IC tag in which face data representing the user's face is recorded into the identity verification document insertion slot 5. Examples of the identity verification document include, but are not limited to, a passport and an Individual Number Card called “My Number Card” under the Japan's Social Security and Tax Number System. When the identity verification document is inserted into the identity verification document insertion slot 5, the control device 12 controls the IC tag reader 11 to acquire the face data recorded in the IC tag embedded in the identity verification document (step S1).

After acquiring the face data, the control device 12 controls the camera 3 to capture an image including a subject that is present in the image capturing space 7 to obtain a captured image (step S2). The control device 12 creates a screen on the basis of the captured image, and controls the display device 2 to display the created screen on the display screen 6 (step S3). In other words, on the display screen 6, the captured image, a during-shooting message, and the first pattern image 35 are displayed. The during-shooting message informs the user that the camera 3 is capturing an image including a subject that is present in the image capturing space 7. The during-shooting message includes, for example, “Capturing an image of your face.” After the screen is displayed on the display screen 6, the user moves his/her face in the image capturing space 7 so that his/her face is displayed on the display screen 6.

The control device 12 performs image processing on the captured image captured by the camera 3 and determines whether a face is present in the captured image (step S4). Based on the determination that the face appears in the captured image, the control device 12 performs image processing on the captured image and detects a face image size (step S5). The face image size indicates the size of a face image representing the face in the captured image. The control device 12 determines whether the detected face image size is within a specified size range that is determined in advance (step S6).

When the face image size is out of the specified size range (step S6: No), the control device 12 controls the display device 2 to display a guidance message on the display screen 6 (step S7). The guidance message prompts a user to move the user's face closer to the camera 3 when the face image size is smaller than the specified size range. The guidance message includes, for example, “Please move closer.” The guidance message prompts a user to move the user's face away from the camera 3 when the face image size is larger than the specified size range. The guidance message includes, for example, “Please move away.”

The user moves his or her face closer to the camera 3 or away from the camera 3 to adjust the position at which the face is placed so that the face image size is within the specified size range. At this time, by referring to the captured image and the guidance message displayed on the display screen 6, the user can perform the adjustment such as moving his or her face closer to the camera 3 or away from the camera 3 in a simple manner, so that the size of the face image is within the specified size range. In other words, by displaying the captured image and the guidance message on the display screen 6, the personal authentication apparatus 10 can make it easy for a user to adjust the position at which the user's face is placed so that the face image size is within the specified size range. After the guidance message is displayed, the control device 12 repeatedly performs the processes of steps S2 to S6 at a sampling cycle that is determined in advance.

When the face image size is within the specified size range (step S6: Yes), the control device 12 performs image processing on the captured image, and determines whether the pattern image that was displayed on the display screen 6 at a time when the captured image was captured appears in the captured image (step S8). After determining whether the pattern image appears in the captured image, the control device 12 determines whether the number of times the process of step S8 is performed is equal to a specified number of times that is determined in advance (step S9).

When the determination result indicates that the number of times the process of step S8 is performed is less than the specified number of times (step S9: No), the control device 12 performs a series of the processes of steps S2 to S8 again. When the series of processes of steps S2 to S8 is performed multiple times, the control device 12 performs the series of processes of steps S2 to S8 such that the pattern image displayed on the display screen 6 in the process of step S3 is different for each series of processes. For example, when the first pattern image 35 is displayed on the display screen 6 in the process of step S3 in the series of processes of steps S2 to S8 previously performed, the control device 12 performs the processes of steps S2 to S8 so that the second pattern image 36 is displayed on the display screen 6 in the process of step S3 in the subsequent series of processes of steps S2 to S8.

When the determination result indicates that the number of times the process of step S8 is performed is equal to the specified number of times (step S9: Yes), the control device 12 determines whether the number of times the pattern image is determined as appearing in the captured image in the process of step S8 is equal to a specified number of times (step S10). When the number of times the pattern image is determined as appearing in the captured image is less than the specified number of times (step S10: No), the control device 12 performs image processing on the captured image and determines whether a face in the captured image is identical to a face represented by the face data acquired in step S1 (step S11).

When the number of times the pattern image is determined as appearing in the captured image is equal to the specified number of times (step S10: Yes) or after the process at step S11 is performed, the control device 12 controls the display device 2 to display a result of the personal authentication (step S12). When the number of times the pattern image is determined as appearing in the captured image is equal to the specified number of times (step S10: Yes) or when the determination result in step S11 indicates that the face in the captured image is not identical to the face represented by the face data acquired from the IC tag, the result of personal authentication indicates that a subject in the captured image is not identical to a person having the face indicated by the face data acquired from the IC tag. When the determination result in step S11 indicates that the face in the captured image is identical to the face represented by the face data acquired in step S1, the result of personal authentication indicates that a subject in the captured image is identical to a person having the face represented by the face data acquired from the IC tag.

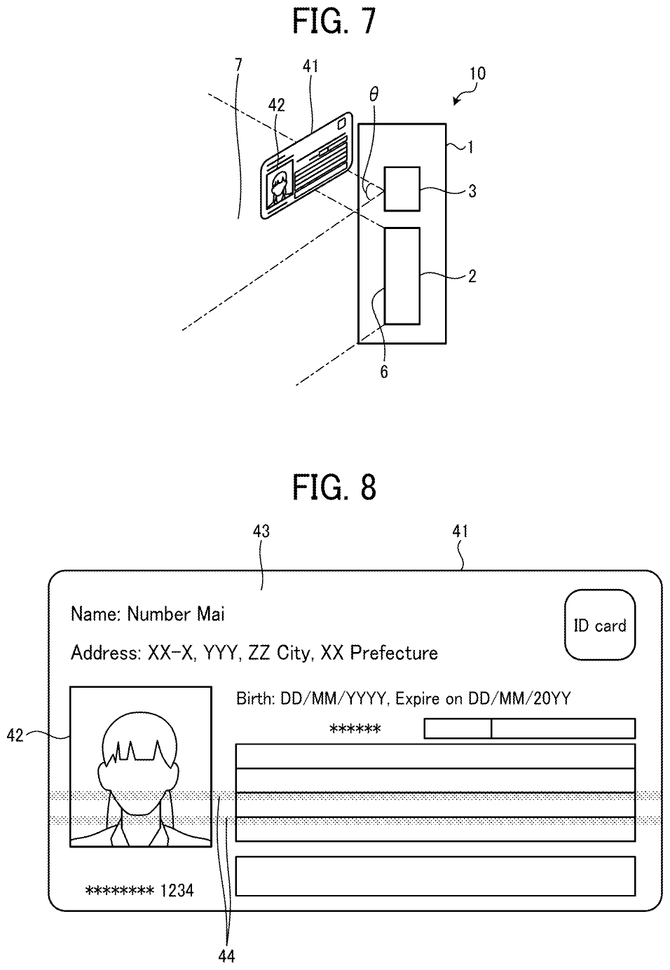

As illustrated in FIG. 7, a user may perform identity fraud with an identity fraud identification (ID) card 41. FIG. 7 is a schematic side view of the personal authentication apparatus 10 and the identity fraud ID card 41 when the user performs identity fraud with the identity fraud ID card 41. Examples of the identity fraud ID card 41 include, but are not limited to, a driver's license and an Individual Number Card called “My Number Card.” The identity fraud ID card 41 includes a face photograph 42. The size of the face photograph 42 is smaller than the size of a human face.

When a user performs identity fraud with the identity fraud ID card 41, the user places the face photograph 42 of the identity fraud ID card 41 in the image capturing space 7 instead of placing the user's face in the image capturing space 7. Since the angle of view θ of the camera 3 is fixed, the user may have to bring the identity fraud ID card 41 closer to the camera 3 than a predetermined distance that is determined in advance so that the face image size is determined as being within the specified size range in step S6.

FIG. 8 is a plan view of the identity fraud ID card 41 brought close to the camera 3. A surface 43 on which the face photograph 42 is provided of the identity fraud ID card 41 is flat and glossy. For this reason, when the distance between the identity fraud ID card 41 and the camera 3 is shorter than the predetermined distance, the pattern image displayed on the display screen 6 is reflected to the surface 43 with the surface 43 as a specular surface, and a mirror image 44 of the pattern image displayed on the display screen 6 appears on the surface 43.

A user can perform identity fraud with another counterfeit different from the identity fraud ID card 41. Examples of the counterfeit include, but are not limited to, a printed matter on which a face photograph is printed, a booklet attached with a face photograph, and a display device that can display a face photograph. Examples of the booklet include, but are not limited to, a passport. Examples of the display device include, but are not limited to, a smartphone.

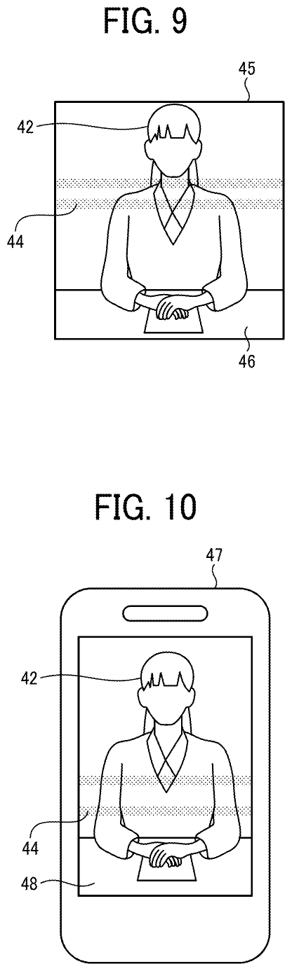

As illustrated in FIG. 9, a face photograph 42 is printed on an identity fraud printed matter 45 that serves as another example of the counterfeit. FIG. 9 is a plan view of the identity fraud printed matter 45 brought close to the camera 3. A surface 46 on which the face photograph 42 is printed of the identity fraud printed matter 45 is flat and glossy like the surface 43 of the identity fraud ID card 41. For this reason, when the distance between the identity fraud printed matter 45 and the camera 3 is shorter than the predetermined distance, the pattern image displayed on the display screen 6 is reflected to the surface 46 with the surface 46 as a specular surface, and the mirror image 44 of the pattern image displayed on the display screen 6 appears on the surface 46.

As illustrated in FIG. 10, a display screen 48 is formed on an identity fraud smartphone 47 that serves as still another example of the counterfeit. FIG. 10 is a plan view of the identity fraud smartphone 47 brought close to the camera 3. The face photograph 42 is displayed on the display screen 48. The display screen 48 is flat and glossy like the surface 43 of the identity fraud ID card 41. For this reason, when the distance between the identity fraud smartphone 47 and the camera 3 is shorter than the predetermined distance, the pattern image displayed on the display screen 6 is reflected to the display screen 48 with the display screen 48 as a specular surface, and the mirror image 44 of the pattern image displayed on the display screen 6 appears on the display screen 48.

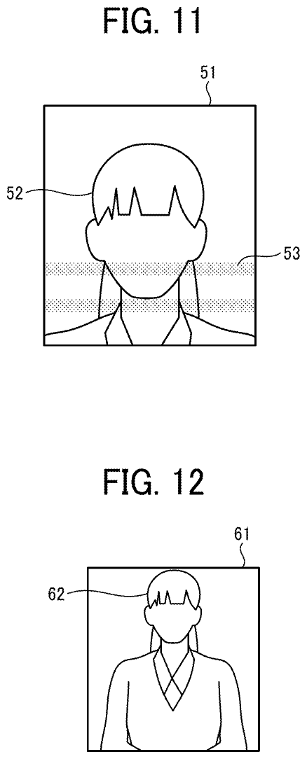

As illustrated in FIG. 11, a face image 52 appears in a captured image 51 captured by the camera 3 when identity fraud is performed in the case where the distance between the counterfeit and the camera 3 is shorter than the predetermined distance. In the following description, the captured image 51 captured by the camera 3 when identity fraud is performed may be referred to as an “identity fraud captured image 51.” FIG. 11 is a diagram illustrating the identity fraud captured image 51 captured by the camera 3. The face image 52 includes the face photograph 42 of the counterfeit, and includes the face in the face photograph 42. When the first pattern image 35 is displayed on the display screen 6 at a time when the identity fraud captured image 51 is captured by the camera 3, reflection 53 further appears in the identity fraud captured image 51. The reflection 53 represents the mirror image 44 appearing on the counterfeit, and presents a pattern image having substantially the same shape as the shape of the first pattern image 35 displayed on the display screen 6. A part of the reflection 53 appears as being superimposed on the face image 52 in the identity fraud captured image 51, and the other part of the reflection 53 appears as being superimposed on a background different from the face image 52 in the identity fraud captured image 51.

Since the angle of view θ is fixed, the user may have to move a face 54 away from the camera 3 so that the distance between the face 54 and the camera 3 is longer than the predetermined distance as illustrated in FIG. 2 so that the face image size is determined as being within the specified size range in step S6. FIG. 12 is a diagram illustrating a captured image 61 captured by the camera 3 when a person's face is placed in the image capturing space 7. In the captured image 61, although a face image 62 appears, the reflection of the pattern image does not appear, since the face is not flat and is away from the camera 3 by the predetermined distance or more.

With this configuration, the personal authentication apparatus 10 can determine in a simple manner whether a subject in a captured image captured by the camera 3 is a human face or a counterfeit on the basis of whether or not the pattern image appears in the captured image, without performing imaging multiple times with different illumination conditions. Further, the personal authentication apparatus 10 is able to determine in a simple manner whether a subject appearing in a captured image captured by the camera 3 is a human face or a counterfeit on the basis of whether or not the pattern image appears in the captured image, without performing complicated image processing. For example, the personal authentication apparatus 10 can determine that a subject in the captured image is a counterfeit when the pattern image appears as being superimposed on a background that is different from a face image in the captured image, instead of performing image processing only on the face image in the captured image. By determining authenticity, the personal authentication apparatus 10 can prevent identity fraud using a counterfeit, and can appropriately verify identity.

When the distance between a counterfeit and the camera 3 is shorter than the predetermined distance and the second pattern image 36 is displayed on the display screen 6, another identity fraud captured image 55 is captured by the camera 3 as illustrated in FIG. 13. FIG. 13 is a diagram illustrating another identity fraud captured image 55 captured by the camera 3. The face image 52 appears in the identity fraud captured image 55, in substantially the same manner as the identity fraud captured image 51. Another reflection 56 appears in the identity fraud captured image 55. The reflection 56 represents a mirror image that appears on the surface of a counterfeit as the second pattern image 36 displayed on the display screen 6 is reflected to the surface of the counterfeit, and represents a pattern image having substantially the same shape as the shape of the second pattern image 36. A part of the reflection 56 appears as being superimposed on the face image 52 in the identity fraud captured image 55, and the other part of the reflection 56 appears as being superimposed on a background different from the face image 52 in the identity fraud captured image 55. Since the shape of the second pattern image 36 is different from the shape of the first pattern image 35, a pattern image appearing as the reflection 56 is different from a pattern image appearing as the reflection 53.

When a foreign object different from a face is placed in the image capturing space 7, a foreign object image representing the foreign object may appear in the captured image captured by the camera 3. Examples of the foreign object include, but are not limited to, a foreign object attached to the personal authentication apparatus 10 or a user, and a pattern of clothing worn by the user. When the shape of the foreign object image is the same as the shape of the reflection 53 representing the first pattern image 35, the control device 12 may erroneously determine that the reflection representing the first pattern image 35 displayed on the display screen 6 appears in the captured image. Since the multiple pattern images different from each other are used in the process of step S8 multiple times, the personal authentication apparatus 10 does not make such an erroneous determination every time. Accordingly, the personal authentication apparatus 10 can more reliably determine whether a subject in the captured image is a human face or a counterfeit.

The subject determination apparatus according to Embodiment 1 includes the display device 2, the camera 3, the display control unit 23, the imaging control unit 22, and the authenticity determination unit 25. The display device 2 includes the display screen 6 facing the image capturing space 7. The camera 3 is disposed so as to capture an image including a subject that is present in the image capturing space 7, and is fixed to the display device 2. The display control unit 23 controls the display device 2 so that the first pattern image 35 is displayed on the display screen 6. The imaging control unit 22 controls the camera 3 so that the captured image including the subject that is present in the image capturing space 7 is captured while the first pattern image 35 is being displayed on the display screen 6. The authenticity determination unit 25 determines whether the first pattern image 35 reflected by the subject appears in the captured image. In other words, the authenticity determination unit 25 determines whether the first display pattern 35 reflected by the subject is included in the captured image.

When the determination result indicates that the first pattern image 35 is included in the captured image, the subject determination apparatus according to Embodiment 1 determines that the subject in the captured image is a counterfeit. When the determination result indicates that the first pattern image 35 does not appear in the captured image, the subject determination apparatus according to Embodiment 1 determines that the subject in the captured image is not a counterfeit. In other words, the subject determination apparatus according to Embodiment 1 can determine in a simple manner whether the subject in the captured image is a counterfeit without performing imaging multiple times with different illumination conditions or performing complicated image processing. The subject determination apparatus according to Embodiment 1 does not have to further include an illuminator for changing the illumination condition. With this configuration, the number of components can be reduced. Thus, the manufacturing cost can be reduced.

Further, the subject determination apparatus according to Embodiment 1 further includes the size determination unit 24 that determines the size of a face image representing a face in the captured image. The angle of view θ of the camera 3 is fixed. The authenticity determination unit 25 determines whether the first pattern image 35 appears in the captured image when the size of the face image representing the face in the captured image is within the specified size range. At this time, the subject determination apparatus according to Embodiment 1 can guide a counterfeit to an appropriate position so that the mirror image 44 of the first pattern image 35 reflected from the surface of the counterfeit appears in the captured image.

Further, the display control unit 23 of the subject determination apparatus according to Embodiment 1 controls the display device 2 so that the captured image is displayed on the display screen 6 together with the first pattern image 35. The display control unit 23 may display the first pattern image 35 in an area different from the captured image area 32. In other words, the first pattern image 35 may be displayed in a first area on the display screen and the captured image may be displayed in a second area that is different from the first area on the display screen. Further, the display control unit 23 may overlay the first pattern image 35 on the captured image on the display screen 6. At this time, by referring to the face image in the captured image, the user can perform the adjustment such as moving his or her face closer to the camera 3 or away from the camera 3 in a simple manner, so that the size of the face image is within the specified size range. In other words, the subject determination apparatus according to Embodiment 1 can facilitate a user's operation of adjusting the size of the face image in the captured image.

Further, the subject determination apparatus according to Embodiment 1 displays the first pattern image 35 in an area on the display screen 6 closer to the camera 3 than an area in which the captured image is displayed. With this configuration, the subject determination apparatus according to Embodiment 1 can make it easy for the mirror image 44 of the first pattern image 35 to appear the captured image. Accordingly, the subject determination apparatus according to Embodiment 1 can more reliably determine whether the subject in the captured image is a counterfeit.

The subject determination apparatus according to Embodiment 1 further includes the authentication target data acquisition unit 21 and the individual identification unit 26. The authentication target data acquisition unit 21 acquires face data. When the authenticity determination unit 25 determines that the first pattern image 35 does not appear in the captured image, the individual identification unit 26 determines whether a face represented by the face data and the face in the captured image are the same on the basis of the captured image. At this time, when the individual identification unit 26 determines that the face represented by the face data is the same as the face in the captured image, the subject determination apparatus according to Embodiment 1 determines that the subject in the captured image is the same as a person having the face represented by the face data acquired by the authentication target data acquisition unit 21. Based on the determination result indicating that the face represented by the face data is the same as the face in the captured image or based on the determination result indicating that the subject in the captured image is a counterfeit, the subject determination apparatus according to Embodiment 1 determines that the subject in the captured image is not the same as the person having the face represented by the face data acquired by the authentication target data acquisition unit 21. In other words, the subject determination apparatus according to Embodiment 1 can detect identity fraud using a counterfeit, and can appropriately verify identity.

Further, the display control unit 23 of the subject determination apparatus according to Embodiment 1 further controls the display device 2 so that the second pattern image 36 different from the first pattern image 35 is displayed on the display screen 6. The imaging control unit 22 controls the camera 3 so that another captured image in which the subject is included is captured while the second pattern image 36 is being displayed on the display screen 6. The authenticity determination unit 25 further determines whether the second pattern image 36 appears in the captured image captured while the second pattern image 36 is being displayed on the display screen 6. When the shape of an image of a foreign object in the captured image is the same as the shape of the reflection of the first pattern image 35, the subject determination apparatus according to Embodiment 1 may erroneously recognize that the subject in the captured image is a counterfeit. The subject determination apparatus according to Embodiment 1 can prevent such an erroneous determination from being made every time by using the multiple pattern images different from each other, and can more reliably determine whether the subject in the captured image is a counterfeit.

The subject determination apparatus according to Embodiment 1 described above repeatedly performs the process of step S8 the specified number of times. Alternatively, the subject determination apparatus may perform the process of step S8 only once instead of performing the process of step S8 multiple times. The subject determination apparatus according to Embodiment 1 can easily determine in a simple manner whether the subject in the captured image is a counterfeit even when the process of step S8 is performed only once.

The camera 3 of the subject determination apparatus according to Embodiment 1 described above is disposed above the display screen 6 of the display device 2. Alternatively, the camera 3 may be disposed on any other side different from above the display screen 6. In this case, the pattern image area 34 is arranged on the screen so that when the pattern image area 34 is displayed on the display screen 6, the pattern image area 34 is displayed near the edge of the display screen 6 on the side closer to the camera 3. Even when the camera 3 is disposed on a side different from the above the display screen 6 of the display device 2, the subject determination apparatus according to Embodiment 1 can appropriately determine whether the subject in the captured image is a counterfeit since the position where the pattern image area 34 is arranged is changed to an appropriate position.

### Embodiment 2

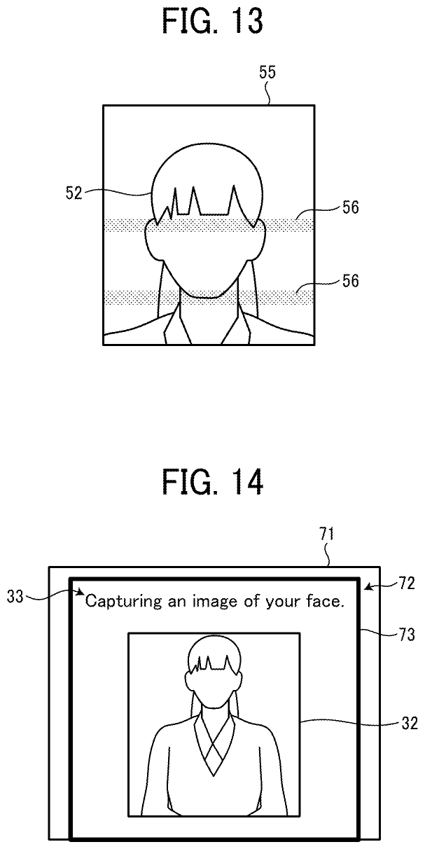

As illustrated in FIG. 14, the subject determination apparatus according to Embodiment 2 is the same as the subject determination apparatus according to Embodiment 1 except that the screen image 31 used in the subject determination apparatus according to Embodiment 1 described above is replaced with another screen 71. FIG. 14 is a diagram illustrating the screen 71 used in the subject determination apparatus according to Embodiment 2. The screen 71 includes the captured image area 32 and the message area 33, in substantially the same manner as the screen image 31 described above. The screen 71 further includes a pattern image area 72. The pattern image area 72 is a portion of the screen 71 surrounding the captured image area 32 along the edges of the screen 71. In other words, the pattern image area 72 is displayed along the edges of the display screen 6 when the screen 71 is displayed on the display screen 6. Any one pattern image 73 of multiple pattern images that are different from each other is displayed in the pattern image area 72. Further, the pattern image area 72 and the captured image area 32 may be overlapped on the display screen.

A personal authentication apparatus provided with the subject determination apparatus according to Embodiment 2 can be used in substantially the same manner as the personal authentication apparatus 10 described above. In other words, the personal authentication apparatus determines that a subject in the captured image is a counterfeit on the basis of the determination that the pattern image appears in the captured image. The personal authentication apparatus determines that the subject in the captured image is not a counterfeit on the basis of the determination that the pattern image does not appear in the captured image. Accordingly, the subject determination apparatus according to Embodiment 2 can determine in a simple manner whether the subject in the captured image is a counterfeit, in substantially the same manner as the subject determination apparatus according to Embodiment 1 described above.

With the use of such the screen 71, the mirror image of the pattern image displayed on the display screen 6 appears in the captured image even when the camera 3 is disposed on any side of the display screen 6. In other words, the computer program installed in the control device 12 of the personal authentication apparatus provided with the subject determination apparatus according to Embodiment 2 can be used to control another personal authentication apparatus in which the camera 3 is disposed on a side other than the above the display screen 6.

The subject determination apparatus according to the above-described embodiments displays the captured image and the message on the display screen 6. Alternatively, the subject determination apparatus does not necessarily have to display both or one of the captured image and the message on the display screen 6. Even when both or one of the captured image and the message is not displayed on the display screen 6, the subject determination apparatus can determine in a simple manner whether a subject in the captured image is a counterfeit by the pattern image being displayed on the display screen 6, in substantially the same manner as the subject determination apparatus according to the above-described embodiments.

The subject determination apparatus according to the above-described embodiments performs identity verification using the face of a user. Alternatively, the subject determination apparatus may perform identity verification using biometric information (physical features) instead of a face. Examples of the biometric information include, but are not limited to, a palm shape, a fingerprint, and a vein pattern. Even when the subject determination apparatus performs identity verification using the biometric information instead of a face, the subject determination apparatus can determine in a simple manner whether a subject in a captured image is a counterfeit, in substantially the same manner as the subject determination apparatus of the above-described embodiments.

The subject determination apparatus according to the above-described embodiments performs identity verification. Alternatively, the subject determination apparatus may determine only the authenticity of whether a subject in a captured image is a counterfeit without performing identity verification. Even in this case, the subject determination apparatus can determine in a simple manner whether a subject in a captured image is a counterfeit.

According to one embodiment of the present disclosure, a subject determination apparatus, a subject determination method, and a non-transitory computer-executable medium are provided that can determine whether a subject in a captured image is a counterfeit in a simple manner.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A subject determination apparatus, comprising:
a display having a display screen;
a camera to capture a subject; and
circuitry configured to:
display a pattern image on the display screen;
obtain an image including the subject while the pattern image is being displayed on the display screen as a captured image; and
determine whether the pattern image reflected by the subject appears in the captured image.

2. The subject determination apparatus of claim 1, wherein
the circuitry is further configured to determine a size of an image representing an authentication target in the captured image,
the camera has a fixed angle of view, and
the circuitry is configured to determine whether the pattern image reflected by the subject appears in the captured image when the determined size of the authentication target is within a predetermined size range.

3. The subject determination apparatus of claim 1, wherein the circuitry is further configured to display the captured image on the display screen together with the pattern image.

4. The subject determination apparatus of claim 3, wherein the pattern image is displayed in a first area on the display screen and the captured image is displayed in a second area that is different from the first area on the display screen.

5. The subject determination apparatus of claim 3, wherein the pattern image is overlaid on the captured image on the display screen.

6. The subject determination apparatus of claim 3, wherein the pattern image is displayed in an area of the display screen closer to the camera than an area in which the captured image is displayed.

7. The subject determination apparatus of claim 1, wherein the circuitry is further configured to:
acquire authentication target data; and
determine whether an authentication target represented by the authentication target data and an authentication target in the captured image are the same based on the captured image when the circuitry determines that the pattern image does not appear in the captured image.

8. The subject determination apparatus of claim 1, wherein the circuitry is further configured to:
display another pattern image different from the pattern image on the display screen;
capture another image including the subject while the another pattern image is being displayed on the display screen to obtain another captured image; and
determine whether the another pattern image appears in the another captured image.

9. The subject determination apparatus of claim 8, wherein the circuitry is further configured to:
acquire authentication target data; and
determine whether an authentication target represented by the authentication target data and an authentication target in the captured image are the same based on the captured image, when the circuitry determines that the pattern image does not appear in the captured image and when the circuitry determines that the another pattern image does not appear in the another captured image.

10. A subject determination method, comprising:
displaying a pattern image on a display screen;
by a camera, capturing an image including a subject while the pattern image is being displayed on the display screen to obtain a captured image; and
determining whether the pattern image reflected by the subject appears in the captured image.

11. A non-transitory computer-executable medium storing a plurality of instructions, which, when executed by one or more processors of a computer, causes the one or more processors to perform a method comprising:
displaying a pattern image on a display screen;
by a camera, capturing an image including a subject while the pattern image is being displayed on the display screen to obtain a captured image; and
determining whether the pattern image reflected by the subject appears in the captured image.
